(19) United States
(12) Patent Application Publication
(10) Pub. No.: US 2001/0020940 A1
(43) Pub. Date: Sep. 13, 2001

(54) Information processor and power control method therefor

(75) Inventors: Ryu Nakazato, Yokohama-shi (JP); Tatsuya Ozawa, Ome-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 09/798,963

(22) Filed: Mar. 6, 2001

(30) Foreign Application Priority Data
Mar. 13, 2000 (JP) 2000-068012

(51) Int. Cl. G06T 1/00; G06F 17/00; G05D 3/12; G05D 5/00; G05D 9/00; G05D 11/00; G05D 17/00

(52) U.S. Cl. 345/418; 700/291

(57) ABSTRACT

In an information processor having a power control function for controlling the power of devices that make up a system, a battery drive time during which the information processor is to be battery-powered is specified by a user. Power control parameters for the devices are computed on the basis of the specified battery drive time. Each of the computed power control parameters is then set up on a corresponding respective one of the devices.

### CROSS-REFERENCE TO RELATED APPLICATIONS

This application is based upon and claims the benefit of priority from the prior Japanese Patent Application No. 2000-068012, filed Mar. 13, 2000, the entire contents of which are incorporated herein by reference.

### BACKGROUND OF THE INVENTION

The present invention relates to an information processor, such as a personal computer, a word processor, an electronic notebook, or the like and more specifically to a device for exercising power control of such equipment.

In recent years, various information processors, such as personal computers, have been developed which can be powered from battery for the intention of being used by users while they are out. Many of desk-top or floor-standing personal computers which are not intended to be carried about are also designed such that they can be powered from battery in order to allow users to continue their current work for a while in the event that external power supply is interrupted by a power failure by way of example.

In order to extend the operating time of the battery as long as possible, the personal computers of such a type have a power saving feature built in, which, when they are powered from the battery, turns off the liquid crystal display (LCD) when data entry from the keyboard is stopped over a predetermined period of time. The power saving feature indicates battery conditions to users in terms of the remaining drivable (available) time of a battery or its residual capacity.

For example, a conventional technique of displaying the available time of a battery (the amount of time the battery can be used) is disclosed in Japanese Unexamined Patent Publication No. 11 - 289677. In this technique, battery residual capacity read means reads the residual capacity from a battery and stores the elapsed time from a reference time and the read battery residual capacity into a battery consumption information table. Battery consumption rate calculate means calculates the battery power consumed between the last timer interruption and the current time from the current residual capacity obtained by the battery residual capacity read means and the latest residual capacity stored in the battery consumption information table and then stores it in the battery consumption information table as a battery consumption rate. Predicted battery available time calculate means calculates the amount of time the information processor can be driven (powered) by the battery from the current residual capacity of the battery and the battery consumption rate obtained by the battery consumption rate calculate means.

The conventional technique merely displays the calculated amount of time the information processor can be powered from the battery. Therefore, the users are not allowed to set the amount of time the information processor is to be powered from the battery.

### BRIEF SUMMARY OF THE INVENTION

It is an object of the present invention to provide an information processor and a power control method therefor which permit a user to specify a desired battery drive time during which the information processor is to be battery-powered and control the battery power until the specified drive time is reached.

According to an aspect of the present invention, there is provided an information processor having a function of controlling the power of devices constituting a system, comprising: means for specifying a battery drive time of the information processor; means for setting either a power ratio or priority of power consumptions of the respective devices; means for calculating power control parameters indicating power consumption states of the respective devices based on the specified battery drive time and the set power ratio or priority of power consumptions; and control means for controlling the power consumption of the respective devices based on the power control parameters calculated by the calculating means.

According to such a configuration, the power of the information processor can be controlled until the user-specified drive time is reached. Furthermore, the information processor can be battery-powered until the user-specified time and either of the ratio or priority of power allocated for the devices of the information processor can be set and changed. In addition, setting the power ratio at each specified time allows the power control of the information processor with time.

The information processor may further comprises: means for obtaining the residual capacity of the battery and the current power consumption of the image processor; second calculating means responsive to the obtaining means for calculating the battery drive time; means for making a comparison between the battery drive time specified by the specifying means and the current drive time calculated by the second calculating means; and means responsive to the comparing means for changing the power control parameters calculated by the calculating means.

According to such a configuration, power control can also be performed while taking account of the characteristics of the battery due to a user-preset value.

The information processor may further comprise means for, at the arrival of the battery drive time specified by the specifying means, executing a predetermined process before the power to the information processor is turned off.

According to such a configuration, a predetermined process, such as a battery discharge process, can be carried out after the user-specified time.

The information processor may further comprise means for indicating a message to a user in the event that the information processor cannot be driven by the battery until the battery drive time specified by the specifying means is reached.

According to such a configuration, the user can be notified through a warning message that the information processor cannot be driven by the battery until the battery drive time specified by the specifying means is reached.

The information processor may further comprise means for changing the battery drive time specified by the specifying means while the information processor is being driven by the battery until the specified drive means is reached.

According to such a configuration, various settings can be changed even if the information processor is running.

According to another aspect of the present invention, there is provided a power control method for use with an information processor having a function of controlling the power of devices constituting a system, comprising the steps of: specifying a battery drive time of the information processor; setting either a power ratio or priority of power consumptions of the respective devices; computing power control parameters indicating power consumption states of the respective devices on the basis of the battery drive time and the set power ratio or priority of power consumptions; and controlling the power consumption of the respective devices based on the power control parameters computed by the computing step.

According to such configurations, the information processor can be battery-powered until the user-specified time and the ratio of power allocated for the devices of the information processor can be set. In addition, setting the power ratio at each specified time allows the power control of the information processor with time.

The method may further comprise the steps of: obtaining the residual capacity of the battery and the current power consumption of the image processor; calculating the battery drive time from the residual capacity of the battery and the current power consumption of the image processor; making a comparison between the battery drive time specified by the specifying step and the current drive time calculated by the calculating step; and changing the power control parameters calculated by the calculating means on the basis of the result of the comparison.

The method may further include the step of obtaining characteristic data of the battery in the information processor and calculating the battery drive time on the basis of the obtained characteristic data of the battery.

According to such a configuration, power control can also be performed while taking account of the characteristics of the battery due to a user preset value.

According to the present invention, the driving time of the information processor can be set and the power control of the battery can be carried out until the driving time is reached.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram for a hardware configuration of an information processor according to an embodiment of the present invention;

FIG. 2 is a block diagram for a software configuration in the information processor of FIG. 1;

FIG. 3 shows a primary setting screen of a power control utility program in the information processor of FIG. 1;

FIG. 4 shows a screen for setting the amount of time the battery is used in the information processor of FIG. 1;

FIG. 5 shows a message screen displayed after the elapse of the set amount of time in the information processor of FIG. 1;

FIG. 6 shows a power condition setting screen in the information processor of FIG. 1;

FIG. 7 shows a power ratio setting screen in the information processor of FIG. 1;

FIG. 8 shows a priority setting screen in the information processor of FIG. 1;

FIG. 9 shows a screen for setting the power ratio at each specified time in the information processor of FIG. 1;

FIG. 10 is a flowchart illustrating an operation of changing power setting at a specified time in the information processor of FIG. 1;

FIG. 11 shows a screen for setting a process to be carried out immediately prior to power off in the information processor of FIG. 1;

FIG. 12 shows a setting screen when the battery power remains in the information processor of FIG. 1;

FIG. 13 is a flowchart illustrating an operation after the power setting in the information processor of FIG. 1;

FIG. 14 shows characteristic data of the battery used in the information processor in the information processor of FIG. 1;

FIG. 15 is a flowchart illustrating an operation of changing the power ratio in the information processor of FIG. 1;

FIG. 16 is a flowchart illustrating an operation of changing the priority in the information processor of FIG. 1;

FIG. 17 is a flowchart illustrating an operation when the set amount of time the battery is used is reached in the information processor of FIG. 1;

FIG. 18 is a flowchart illustrating an operation of changing the set amount of time the battery is used in the information processor of FIG. 1;

FIG. 19 is a flowchart illustrating an operation of outputting a warning message when the time setting is changed in the information processor of FIG. 1;

FIG. 20 shows a specified time changing message screen (window) in the information processor of FIG. 1;

FIG. 21 is a flowchart illustrating an operation immediately prior to power off in the information processor of FIG. 1; and

FIG. 22 is a conceptual view indicating that respective devices are subjected to power save operation.

### DETAILED DESCRIPTION OF THE INVENTION

An embodiment of the present invention will be described hereinafter with reference to the accompanying drawings.

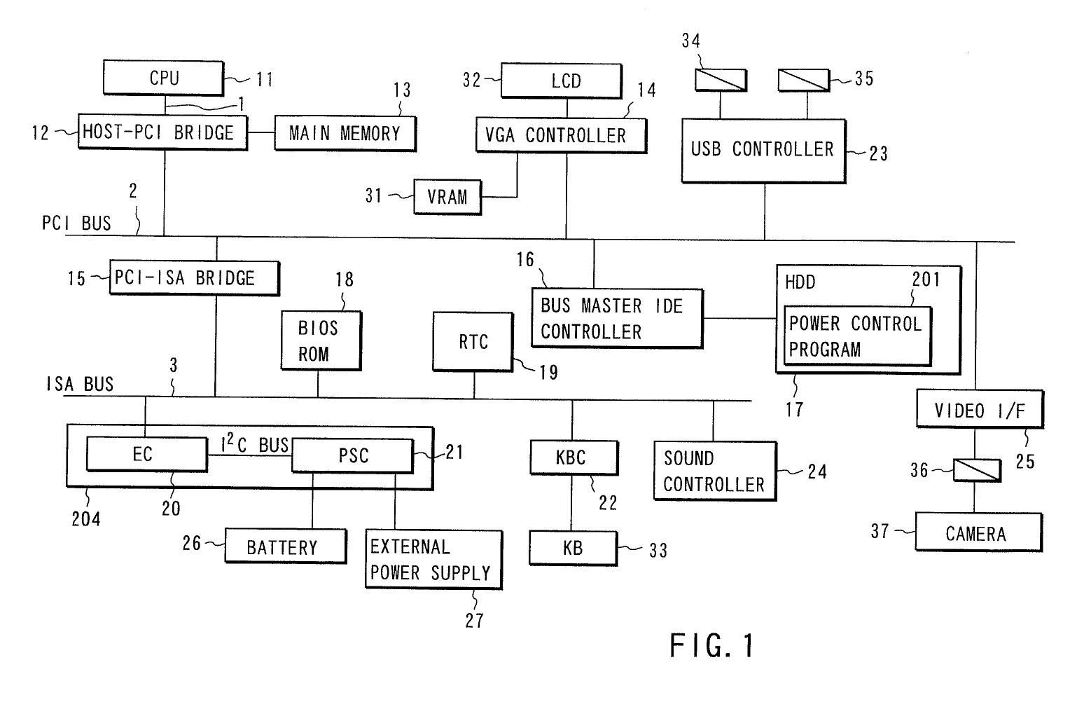

FIG. 1 is a block diagram illustrating a hardware configuration of an information processor to which the invention is applied.

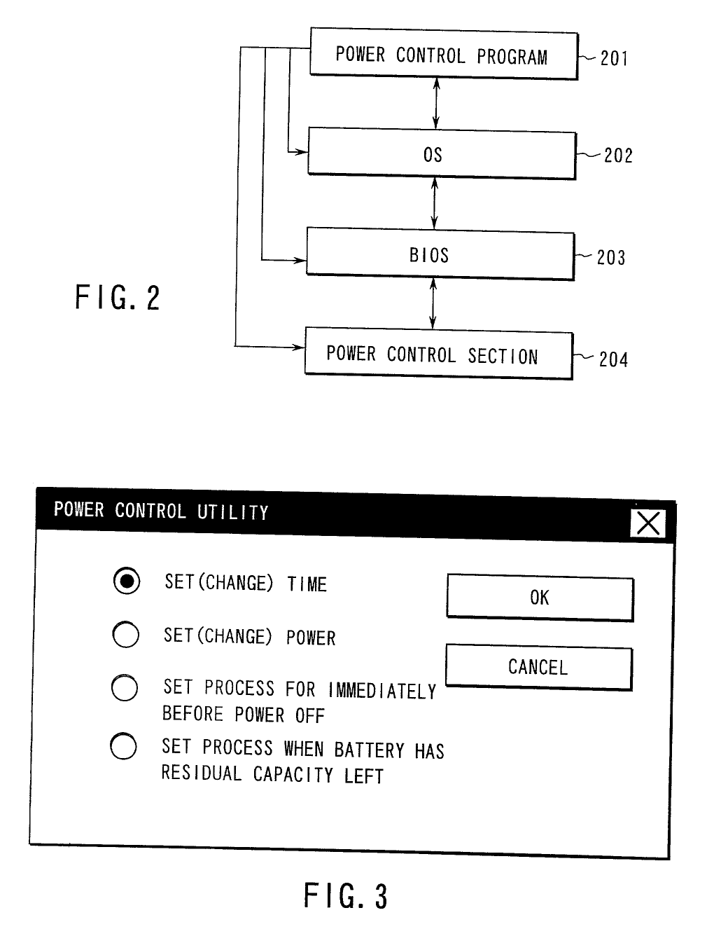

FIG. 2 is a block diagram illustrating a software configuration of the information processor.

The information processor, which is a portable personal computer of a notebook or pocket type, comprises a body and an LCD panel unit attached to the body. The information processor has a built-in battery and can run on the battery power. It can also be powered from an external power supply, such as AC commercial power supply through an AC adapter. When the information processor is powered from the external power supply, the external power supply is used as its operating power supply. At this time, the built-in battery is automatically charged by the external power supply. When the AC adapter is unplugged or a circuit breaker of the AC commercial power supply is dropped out, the built-in battery comes to be used as the operating power supply of the information processor.

In this embodiment, a hinge portion of the body which supports the LCD panel unit rotatably is equipped with an electronic camera 37 for taking a picture of the face of an operator (user).

The information processor body is equipped with a hard disk drive (hereinafter referred to as HDD) 17 having an IDE interface. The HDD 17, used as secondary storage of the information processor, is installed with various applications, such as audio, voice record, mail reading, Internet startup, video camera, electronic camera, etc.

In this embodiment, the HDD 17 is stored with a power control program 201 and an operating system (hereinafter referred to as OS) 202 (see FIG. 2) for notifying the power control program 201 of battery capacity events.

On the system board of the information processor mounted are a CPU 11, a host-PCI bridge 12 connecting a CPU bus 1 and a PCI bus 2 together, a main memory 13, a graphics controller (hereinafter referred to as VGA) 14, a PCI-ISA bridge (PCI/ISA bus bridge) 15, a bus master IDE controller 16, a BIOS-ROM 18, a real-time clock (RTC) 19, an embedded controller (EC) 20, a power supply controller (PSC) 21, a keyboard controller (KBC) 22, a universal serial bus (USB) controller 23, a sound controller 24, and an image interface (I/F) 25. The EC 20 and the PSC 21 make up a power controller 204.

The CPU 11 exercises control of the overall operation of the information processor and data processing according to various control programs (hereinafter referred to as BIOS) stored in the BIOS-ROM 18 (FIG. 2), and the application programs and the OS 202 loaded from the HDD 17 into the main memory 13. Here, the CPU executes the inventive power control program 201 to perform power control in such ways as shown in FIGS. 3 through 21.

The host-PCI bridge 12 has a built-in circuit which controls the main memory 13 in the information processor and the entire I/O.

The main memory 13, which is used as main storage of the information processor, stores the OS 202, an application program which is an object of processing, and user data created by the application program. The inventive power control program 201 is loaded into the main memory 13 as requested by the user. The main memory is implemented by a semiconductor memory such as an SDRAM.

The power control program 201 stores in a work area on the main memory 13 data on the current power consumption, the current residual capacity, the power ratio settings, the priority settings, the maximum charged capacity, the remaining drive time, etc. The functions of the power control program and processing of various values set in the work area will be described later in detail.

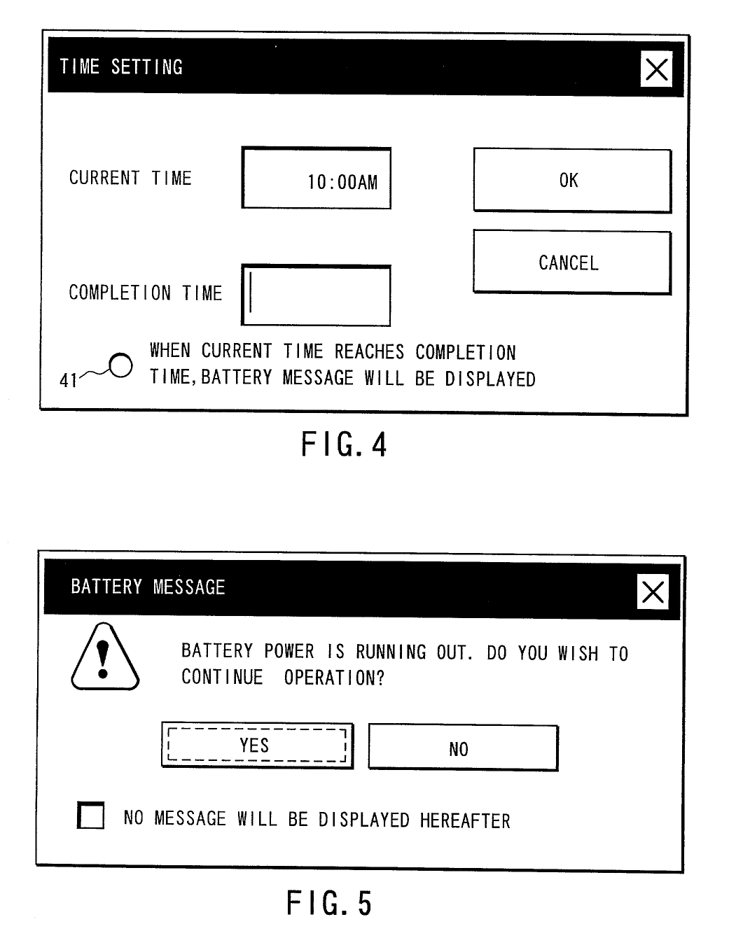

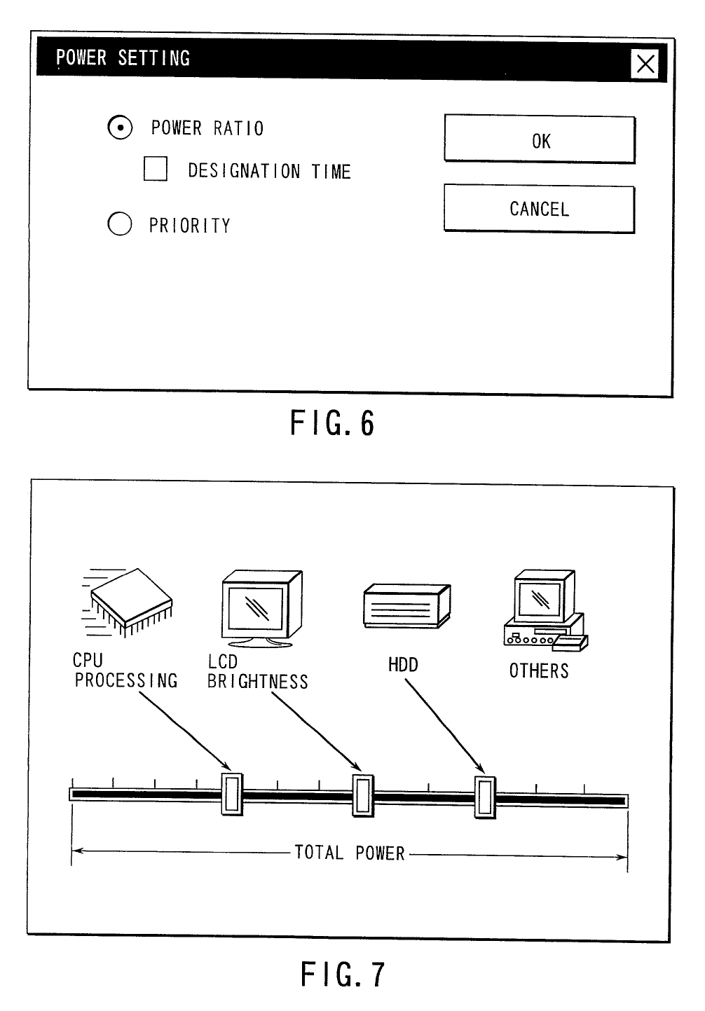

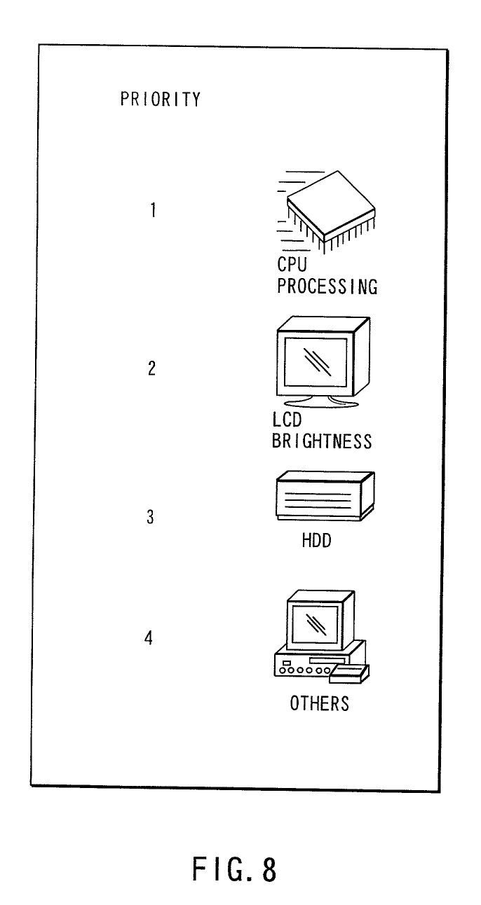

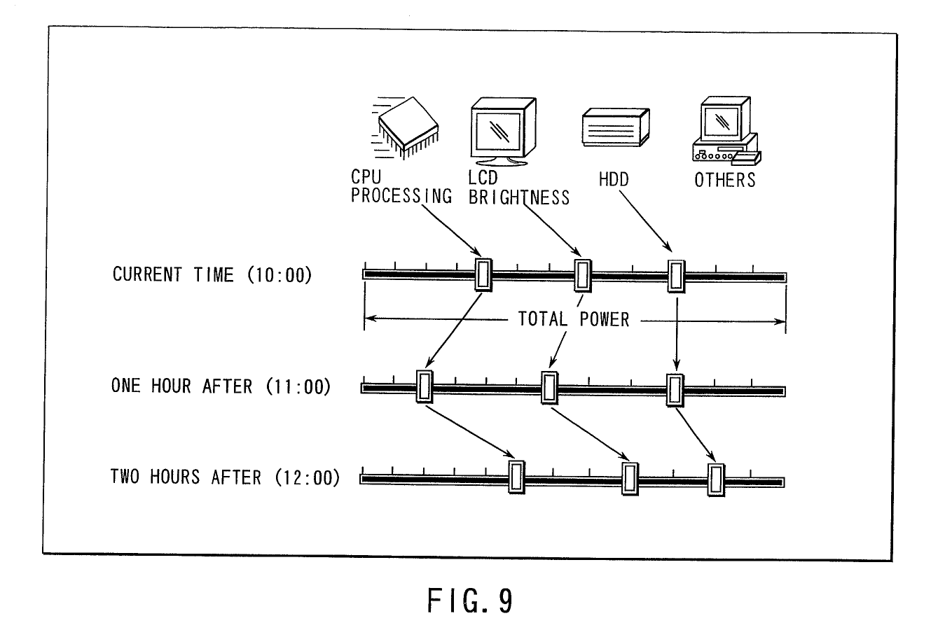

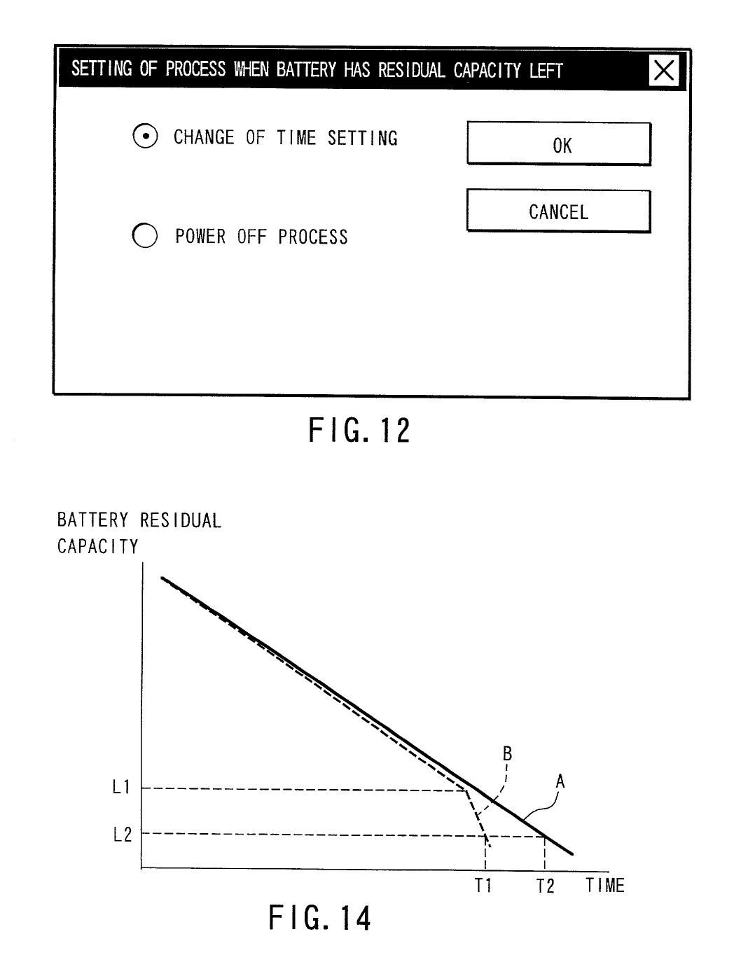

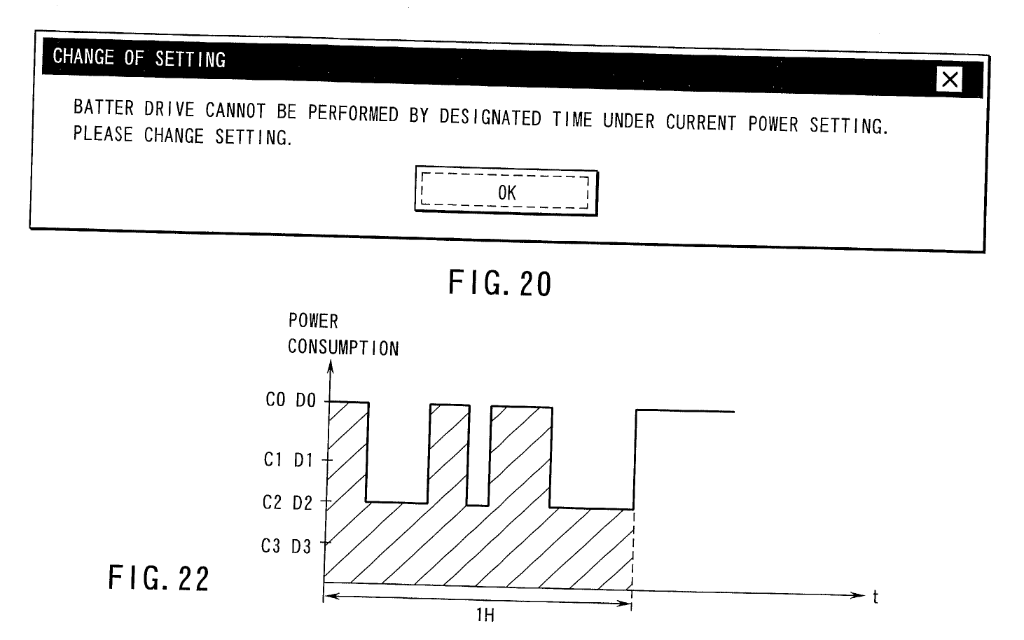

The VGA controller 14 displays information on LCD 32 in the LCD panel unit used as a display monitor of the information processor. Here, there appear such a primary setting screen of the power control program 201 as shown in FIG. 3, such a setting screen for allowing the user to specify a time until which the information processor is to be powered from the battery as shown in FIG. 4, such a message screen at the arrival of the specified time as shown in FIG. 5, such a power setting screen as shown in FIG. 6, such a power ratio setting screen as shown in FIG. 7, such a priority setting screen as shown in FIG. 8, such a screen for setting the power ratio at each specified time as shown in FIG. 9, such a screen for setting a process to be performed immediately prior to power off as shown in FIG. 11, such a screen for setting a process to be performed when the battery power is still available as shown in FIG. 12, and such a screen for prompting the user to change the time setting as shown in FIG. 20.

The PCI-ISA bridge 15 is a bus bridge that connects the PCI bus 2 and ISA bus 3 together. The bus master IDE controller 16, which is adapted to control the IDE device (HDD 17) attached to the information processor body, provides a bus master function capable of DMA transfers between the IDE device and the main memory 13.

The BIOS-ROM 18, adapted to store the system BIOS 203, is implemented by a flash memory that can be reprogrammed. An organization of function execution routines for accessing various pieces of hardware within the information processor, the system BIOS 203 is configured to operate in the real mode and includes an IRT (Initial Reliability Test) routine executed at power-on time and BIOS drivers for controlling various pieces of hardware. To provide multiple hardware-controlling functions to the operating system and the application programs, each BIOS driver contains multiple function execution routines corresponding to the functions. For example, in response to a given event from the EC 20, the BIOS drivers inform the operating system 202 stored in the main memory 13 of an event concerning a change in the residual capacity of the battery which is obtained via the EC 20 and the PSC 21.

The RTC 19, which is a time-keeping module, has a CMOS memory backed up by its own battery. The CMOS memory is stored with various items of system configuration information including information for specifying the power-up mode.

The EC 20, which is a controller for controlling additional functions of the system, has a power sequence control function for on-off control of the power supply of the information processor in conjunction with the power supply controller 21, a power supply status (e.g., the residual capacity of the battery) informing function, etc. The power supply controller 21 is connected with the EC 20 by an I²C bus for communication therebetween and controls the battery 26 and the external power supply 27.

The keyboard controller 22 controls key entry from a keyboard (KB) 33. The USB controller 23 controls external equipment attached to a USB port 34 and a remote control port 35. The sound controller 24 is connected to the ISA bus 3 to control audio output to a speaker or headphone and audio input from a microphone. The image interface 25 is installed between the PCI bus 2 and a camera connector 36 to which the electronic camera 37 is interfaced, the camera being provided, as described previously, in a hinge portion of the image processor body which supports the LCD panel unit rotatably to shoot the user's face. The devices subjected to power control conform to ACPI standards.

Next, various setting operations of the power control program 201 according to an embodiment of the invention will be described with reference to FIGS. 3 through 20.

FIG. 3 is main setting screen display, FIG. 4 is a setting screen display used to specify battery-based driving, and FIG. 5 is a prompting message screen display at the arrival of the set time.

First, the power control program 201 stored on the HDD 17 is activated and loaded into the main memory 13. The power control program carries out a setting operation to allow the information processor to be powered by the battery for a predetermined period of time.

That is, when the power control program 201 is executed, the power control utility setting screen shown in FIG. 3 appears. As shown, options for time setting, power setting, immediately-before-power-off process setting, and process setting when the battery power remains are displayed. Of these items, the time setting is indispensable. Any combination of the time setting with the power setting, the immediately-before-power-off process setting, and/or the process setting when the battery power remains may be used. To drive the information processor by the battery, the user simply clicks the radio button for the time setting (changing) and then chooses (clicks) the OK button. Then, the time setting screen as shown in FIG. 4 appears.

On the screen shown in FIG. 4 are displayed the current time and a box in which a completion time is to be entered. In this screen, the user enters a time at which the battery-based driving of the information processor is to be completed. For example, in FIG. 4, the current time is indicated to be 10:00 A.M. To set a desired driving time, the user enters a completion time at which the battery-based driving is to be completed. When the user chooses the OK button after the entry of the completion time, the power control program 201 calculates the set driving time, or the remaining driving time by subtracting the current time from the completion time and then stores the calculation in the work area of the main memory 13. A method for controlling respective devices using power control parameter values will be explained below. FIG. 22 is a conceptual view indicating that respective devices are subjected to power consumption operation. In this FIG. 22, y-axis indicates power consumption and x-axis indicates time. D0 indicates a full power state, and D1 to D3 indicate depths of sleep, respectively. That is, D1 indicates an idling state, D2 indicates a standby state, and D3 indicates an OFF state. The minimum power consumption can be obtained in the state of D3. Now, in a state where power is not controlled, each device operates with a full power. Therefore, the level of the power consumption is in the state of D0. Then, when one device is not used for a predetermined time (for example, 5 minutes), the power consumption is lowered to the level of D2. When a user uses one device again, the power consumption is returned back to the level of D0. Also, when a user does not use one device for a while, the power consumption is returned back to the level of D2. In FIG. 22, a shadow portion shows the power consumption. Thus, the power consumption is saved. Since the level of D3 is the deepest in the sleep, a time required for the device to recover a full power operation is make long correspondingly. Accordingly, in view of a user's convenience, the level to be lowered is determined according to a time period when a device is not used.

For example, when a hard disk is not used for 5 minutes, the power consumption is lowered to the level of D2 so that the power consumption per hour becomes 0.8 W. Also, when the device is not used for 10 minutes, the level is lowered to D1 so that the power consumption per hour becomes 1.2 W. Thus, predetermined conditions are held in a registry file. Respective devices are controlled on the basis of these conditions. The power consumption will be explained about a CPU, a hard disk and a sound chip.

The CPU has four power consumption states C0 to C3 like the device. C0 indicates a full power state, and C1 to C3 respectively indicate an idling state, a standby state and an OFF state.

Now, it is assumed that the three power consumption states of the CPU are stored in the registry file.

(1) C0 state: This is a full power state (when the clock frequency is 1 GHz, for example), where the power consumption is 10 W.

(2) When the clock frequency is changed from 1 GHz to 500 MHz using the SpeedStep function (function which operates the CPU with a low voltage when it is operated at a low frequency), the power consumption is 7 W.

(3) Furthermore, when the SpeedStep function and the StopClock function are used, the power consumption is the lowermost 5 W.

Also, the power ratio of the CPU is preliminarily set to, for example, 50% as default.

Like the above, it is assumed that the power ratio of the hard disk is set to 10% as default, and only D2 is used in the power saving state, for example.

(1) The power consumption of the full power operation (D0 state) is 1.5 W.

(2) In a case that, when the hard disk is not used for 10 minutes, the level is lowered to D2, the power consumption is 1.0 W.

(3) In a case that, when the hard disk is not used for 2 minutes, the level is lowered to D2, the power consumption is the lowermost 0.7 W.

Like the above, it is assumed that the power ratio of the sound chip is 5%, and the sound chip is set to the power saving state when 5 minutes elapses after completion of sounding, for example.

(1) The power consumption is 0.5 W in a full power state (always D0).

(2) In a case that, when the sound chip is not used for 5 seconds, the level is lowered to D1, the power consumption is 0.3 W.

(3) In a case that, when the sound chip is not used for 5 seconds, the level is lowered to D2, the power consumption is 0.1 W.

(4) In a case that, when the sound chip is not used for 5 seconds, the level is lowered to D3, the power consumption is the lowermost 0.05 W.

It is assumed that the power control conditions of the respective devices such as described above are held in, for example, the registry file.

Now, it is assumed that, when the remaining capacity of the battery is 30 W, a user specifies the driving time to 3 hours. In this case, the power per hour becomes 10 W. Meanwhile, on the basis of the above conditions, since the lowermost power consumption of the CPU is 5 W, the lowermost power consumption of the hard disk is 0.7 W, and the lowermost power consumption is 0.05 W, the total lowermost power consumption becomes 5.75 W. On the other hand, the power consumption of the CPU is 10 W, that of the hard disk is 1.5 W and that of the sound chip is 0.5 W at the full power time. Therefore, the total power consumption at the full power time becomes 12 W. For this reason, the powers of the respective devices are controlled such that the total power consumption of the CPU, the hard disk and the sound chip becomes 10 W. In this case, for example, when the power consumption of the CPU is lowered to the state (2), the power consumption becomes 7 W. Therefore, the total power consumption of the CPU, the hard disk and the sound chip becomes 9 W which is within 10 W. Accordingly, the power control program 201 transmits a message using the SpeedStep to the CPU via OS. Thereby, in the CPU, the clock frequency becomes 500 MHz and the power consumption becomes 7 W.

Also, for example, in the example described above, the calculated power per hour is 10 W. For example, however, when the power per hour is further small such as 8.1 W, for example, the power consumption of the CPU is lowered to the state (2), the power saving state of the hard disk is lowered to the state (2) (namely, the level is lowered to D2 when the hard disk has not been used for 10 minutes), and the power saving state of the sound chip is lowered to the state (3) (namely, the level is lowered to D2 when the sound chip has not been used for 5 seconds). Thereby, the power saving program transmits the use of the SpeedStep to the CPU via the OS, as described above. Furthermore, the power control program monitors access of the OS to the hard disk, and it transmits a message that the level is lowered to D2 to the hard disk via the OS by using ACPI command in response to a timer interruption signal when it is determined from an internal timer the hard disk has not been used for 10 minutes. Moreover, the power control program monitors access of the OS to the sound chip like the above, and it transmits a message that the level is lowered to D2 to the sound chip using ACPI command when the sound chip has not been used for 5 seconds.

There is further provided a radio button 41 to choose whether or not to display such a battery message as shown in FIG. 5 when the current time reaches the completion time.

The time setting may be made by the driving time during which the information processor is to be powered from the battery rather than by the completion time at which the battery driving is to be completed.

The power control program 201 has a function of indicating a battery message to the user upon determining that the set driving time has been reached. When the battery message output is selected, a message to the effect that “Battery power is running out. “Do you wish to continue operation ?” is indicated to the user as shown in FIG. 5.

Next, a description is given of an operation of setting up power conditions, such as the ratio or priority of power allocated for devices, such as the CPU 11, LCD 32, HDD 17, etc., that make up the information processor.

FIG. 6 is a power setting screen of the power control program 201. FIG. 7 shows a power ratio setting screen. FIG. 8 shows a priority setting screen, and FIG. 9 shows a power ratio setting screen for setting a power ratio at each specified time.

When the power setting item is selected in FIG. 3, two setting items as shown in FIG. 6 are displayed. When the power ratio setting item is selected after the driving time has been set, such a screen as shown in FIG. 7 appears on which the ratio of power consumption allocated for devices, such as the CPU 11, the LCD 32, the HDD 17, and others, is set. The maximum, the average and the minimum power consumption of each device have been previously stored in the main memory 13. The power control program 201 reads the average power consumption of each device and then calculates the total power consumption required to operate the information processor for the set driving time. Each of the calculated power control parameters is set up on a corresponding respective one of the devices.

Now, it is assumed that driving is performed for 3 hours and the remaining capacity of the battery is 30 W. Furthermore, it is assumed that a user designates the power ratios of the CPU, the hard disk and the sound chip to 50%, 10% and 5%, respectively. In this case, when it is assumed that the power per hour is 10 W and the total lowermost power consumption is 5.75 W, 4.25 W obtained by subtracting 5.75 W from 10 W is distributed such that 2.1 W, 0.4 W and 0.2 W are respectively allocated to the CPU, the hard disk and the sound chip. Accordingly, the power consumption of the CPU becomes 7.1 W, the power consumption of the hard disk becomes 1.1 W and the power consumption of the sound chip becomes 0.25 W. The values closest to these values are selected from the above described power saving conditions. As a result, a message that the SpeedStep is used is transmitted from the power control program to the CPU, a message that the level is lowered to D2 when the hard disk has not been used for 10 minutes is transmitted to the hard disk, and a message that the level is lowered to D1 when the sound chip has not been used for 5 seconds is transmitted to the sound chip.

Incidentally, in a case that the power ratio is determined for each predetermined time, even when the same ratio is set, the remaining capacity of the battery is changed according to a user's usage. Therefore, the power distributed to the respective devices is calculated for each predetermined time, and power control parameter values are set on the basis of the power consumption states saved in the registry file described above.

The power ratio allocated among the devices can be set variably by moving slider indicators in the slider scale shown in FIG. 7 within the range between the minimum and the maximum power consumption of each device. In this example, the power ratio is determined by the numbers of divisions between each indicator, between the left end of the scale and the leftmost indicator, and between the right end of the scale and the rightmost indicator in the slider scale. In the example of FIG. 7, three divisions are allocated for CPU processing, two division for LCD brightness, one division for HDD, and two divisions for others. The power ratio among the devices is determined by these division numbers. In this embodiment, the power control program 201 sets up a power control parameter calculated from the power ratio setting on each device and stores the parameter settings in the work area of the main memory 13.

When the priority item is selected in FIG. 6, such a priority setting screen as shown in FIG. 7 appears. In this embodiment, the priority of the devices can be established by dragging and dropping each on-screen device icon onto a priority number.

The power control program 201 reads the minimum power consumption of each device and the current power of the battery from the main memory 13 and then subtracts the sum of the minimum power consumptions of the devices from the current power of the battery to obtain the residual power. The program allocates the residual power of the battery to the devices in accordance with the set priority of the devices, e.g., in the priority sequence that CPU>LCD>HDD>others. The power allocated for each device at this time is determined based on a predetermined power ratio. The power control program sets a power control parameter for each device which indicates its priority and stores the parameter settings in the work area of the main memory 13.

When a priority order is specified, the total addition value of the lowermost power consumption of the respective devices is subtracted from the value of the remaining capacity of the battery on the basis of the power ratio preset according to the priority order, and the remaining capacity is divided on the basis of the above power ratio to be added to the lowermost power consumption values of the respective devices. A value closest to the value obtained by the addition is selected from the above-mentioned power saving conditions. Like the case of the power ratios, the states of the power saving are transmitted to the respective devices.

When a completion time is specified on the power setting screen of FIG. 6, the power ratio among the devices of one and two hours after the current time (10:00 A.M.) can be set as shown in FIG. 9. These hour settings in FIG. 9 are merely exemplary. Any hour may be set. To this end, the information processor may be configured to allow the user to enter the power ratio of any time after the current time.

In the example of FIG. 9, suppose, for example, that CPU processing is not particularly required at 11:00 A.M. one hour after the current time because of preparations for reference material for a meeting in the office. In such a case, the power consumption allocated for CPU can be set to a minimum. As a result, the user is allowed to set the power consumption for LCD and HDD high. From 12:00 A.M. two hours after the current time, CPU's high processing power is needed because of computer-based presentation. The user therefore sets the power consumption for CPU high and the power consumption for LCD and HDD low.

Thus, the power ratio among the devices can be set variably by changing the ratio of power allocated for the devices at each specified time. The time at which the power ratio is to be changed can be entered from the keyboard 33. The power control program 201 sets up each of power control parameters calculated based on the power ratio among the devices at each specified time on the corresponding device and stores the parameter settings in the work area of the main memory 13 as well.

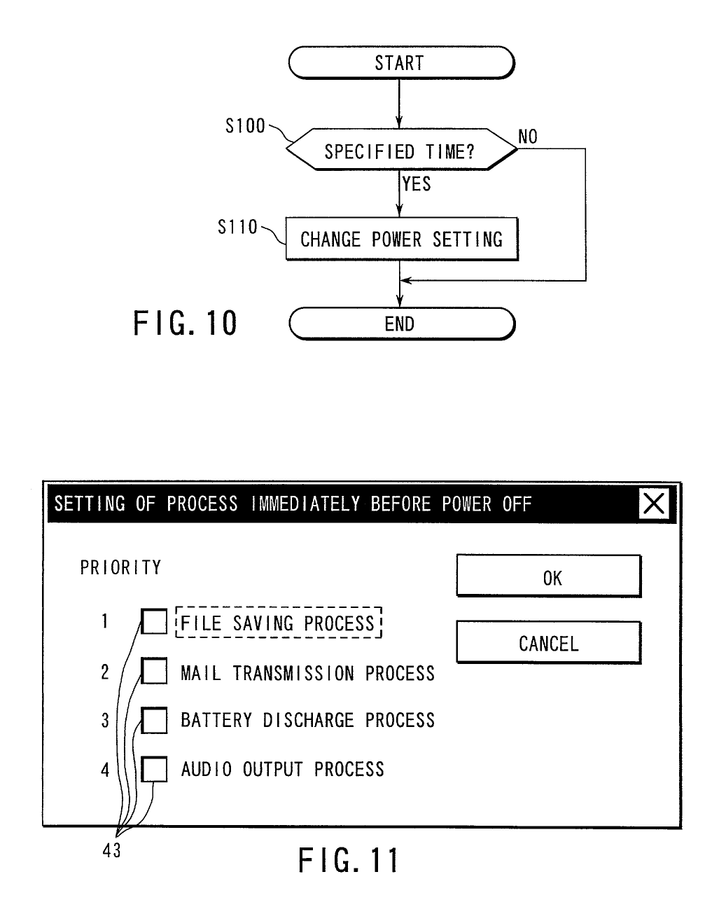

Next, reference is made to a flowchart of FIG. 10 to describe an operation of changing power setting conditions of the power control program 201 at each specified time.

After the settings on the power setting screen shown in FIG. 6 have been entered, the power control program 201 receives time invent information sent from the RTC 19 at regular intervals to make a decision of whether or not a specified time is reached at which the power setting conditions are to be changed (S100). If the decision is that the specified time has been reached, then the changed values of power control parameters indicating the power ratio among the devices (the user-set power ratio or the default power ratio) are read from the main memory 13 and then set on the respective devices (S110). If the decision in S100 is that the specified time is not yet reached, then the power control program 201 comes to an end.

When the immediately-before-power-off process item is selected in FIG. 3, the process setting screen shown in FIG. 11 appears. Here, a selection or selections can be made from (1) a process of saving a file which is open or has not yet been stored on the HDD, (2) a process of sending mail untransmitted, (3) a process of completely discharging the battery for refreshing purpose, and (4) a process of providing audible indication to the user before a process of turning off the power to the information processor is carried out. On the immediately-before-power-off process setting screen, priority can be established among these processes. There are two ways to establish the priority. The first way is to enter priority numbers (1 through 4) into input boxes 43. The second way is to drag and drop each process name to a priority number, so that the selected priority number appears in the corresponding box. In this manner, the user is allowed to establish the priority among the immediately-before-power-off processes. The power control program then stores the immediately-before-power-off process settings in the work area of the main memory 13.

Next, an operation of setting a process when the battery power is still available will be described. When the “setting of process when battery has residual capacity” is selected on the screen shown in FIG. 3, such a screen as shown in FIG. 12 appears. FIG. 12 shows a setting screen of the power control program when the battery power is still available.

Even when the information processor has been powered from the battery until a specified time is reached, the battery power may be left because of the relationship among power consumptions of the devices. Setting options when the battery power is left include a process of changing the time setting and a process of turning the power off (the immediately-before-power-off process+the power-off process). When the process of changing the time setting is chosen, the time setting screen of FIG. 4 appears. When the process of turning the power off is chosen, the immediately-before-power-off process is carried out even if the battery power is left when the specified time is reached. After a process when the battery power is left has been set, the power control program 201 stores the process setting in the work area of the main memory 13.

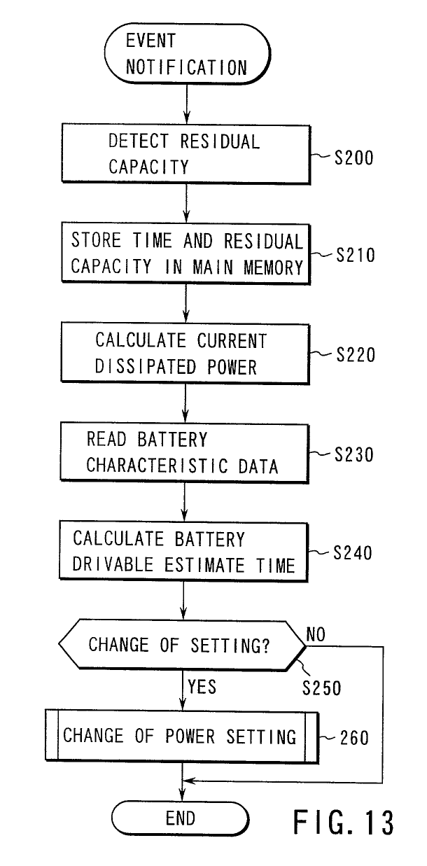

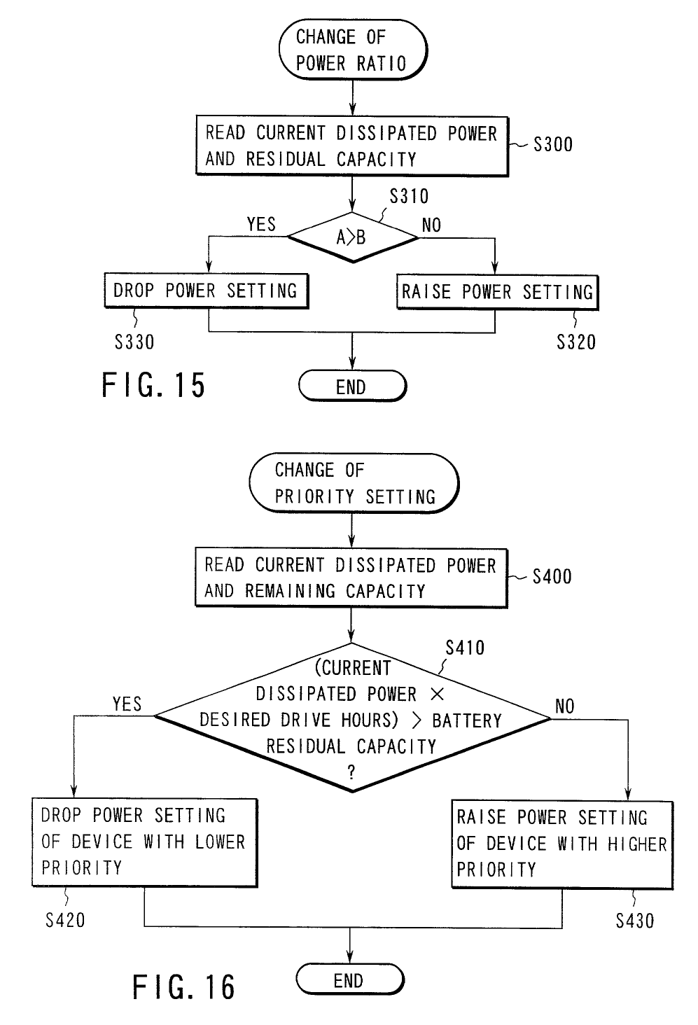

Next, a description is given of an operation when a completion time of battery driving has been set on the setting screens of FIGS. 3 and 4 and moreover power-ratio- or priority-based power setting has been made on the screens of FIGS. 6 to 9. FIG. 13 is a flowchart illustrating an operation after the power setting of the power control program 201 has been registered. FIG. 14 shows characteristic data of the battery. FIGS. 15 and 16 are flowcharts illustrating operations of changing the power control parameters already set in the power setting process.

The power controller 204 detects the voltage and current of the battery 26 in the information processor. Variations in the residual power of the battery are calculated at regular intervals on the basis of the detected voltage and current. The power controller presents the variations in the battery residual power as invents to the BIOS 203 and the OS 202. The power control program 201 receives notification of the events from the power controller 204 via the BIOS 203 and the OS 202. The power control program is responsive to the event notification to obtain the residual power of the battery from the power controller 204. Upon receipt of event notification of variations in the residual power of the battery from the PSC 21, the program 201 stores the battery residual power obtained from the PSC 21 and the time information obtained from the RTC 19 in the work area of the main memory 13 (S200 and S210).

The power control program 201 reads the power control parameters of the respective devices from the main memory 13 and then calculates current power consumption (S220). The current power consumption is then stored in the work area of the main memory.

Next, the power control program 201 reads battery characteristic data from the main memory 13 and then calculates a predicted time during which the battery power is available on the basis of the current power consumption.

The battery characteristic data is read from an EEPROM built in the battery pack when a battery is put in the information processor and stored in the work area of the main memory 13. The available time of the battery is calculated from its current residual power on the basis of the calculated current power consumption and then corrected taking its characteristic data into consideration.

The battery characteristic data varies from battery to battery and from manufacturer to manufacturer. That is, as shown in FIG. 14, there exist batteries A and B of different characteristics. The power of the batteries A and B is dissipated at substantially the same rate until the residual capacity L1 is reached. Immediately after time T1, the power of the battery B drops sharply. Here, the residual capacity L2 is assumed to be the minimum capacity required to drive the information processor. The battery A can be used until time T2, whereas it is only until time T1 that the battery B can be used. In such a case, the power control program 201 corrects the calculated battery available time on the basis of characteristic data of the battery B put in the information processor.

The power control program 201 determines whether or not the current power setting allows the battery to be used until the user-specified time stored in the main memory 13. That is, a comparison is made between the battery available time calculated in S240 and the user-specified time. When the determination is that the battery cannot be used until the user-specified time, that is, when the battery power is short, or when the battery power is enough, the power control program changes the power control parameters set by the user on the power setting screens of FIGS. 6 to 9 (Yes in S250).

The power control program 201 determines which of the power ratio and the priority has been set on the power setting screen on the basis of data stored in the main memory 13 (S260).

When determining that the information processor is being battery-powered according to the current power ratio, the power control program 201 reads the current power consumption and the battery's residual capacity from the main memory 13 and then makes a comparison between (current power consumption×desired driving time) and the battery's residual capacity (S300 and S310). When the comparison indicates that the battery's residual capacity is smaller, i.e., when the battery power is short, such power control parameters as reduce the power consumption of the devices are calculated in such a way as not to change the power ratio already set as much as possible (No in S310 and S320). If, on the other hand, the comparison indicates that the current battery residual capacity is greater, i.e., when the battery power is enough, such power control parameters as increase the power consumption of the devices are calculated in such a way as not to change the power ratio already set as much as possible (Yes in S310 and S330).

When determining that the information processor is being battery-powered according to the current priority, the power control program 201 reads the current power consumption and the battery's residual capacity from the main memory 13 and then makes a comparison between them (S400 and S410). When the comparison indicates that the battery's residual capacity is smaller, i.e., when the battery power is short, such power control parameters as reduce the power consumption of the devices of low priority are calculated (Yes in S410 and S420). If, on the other hand, the comparison indicates that the current residual capacity is greater, i.e., when the battery power is enough, such power control parameters as increase the power consumption of the devices of high priority are calculated (No in S410 and S430).

By setting up the newly calculated power control parameters on the devices, the information processor can be battery-powered until the user-specified time is reached.

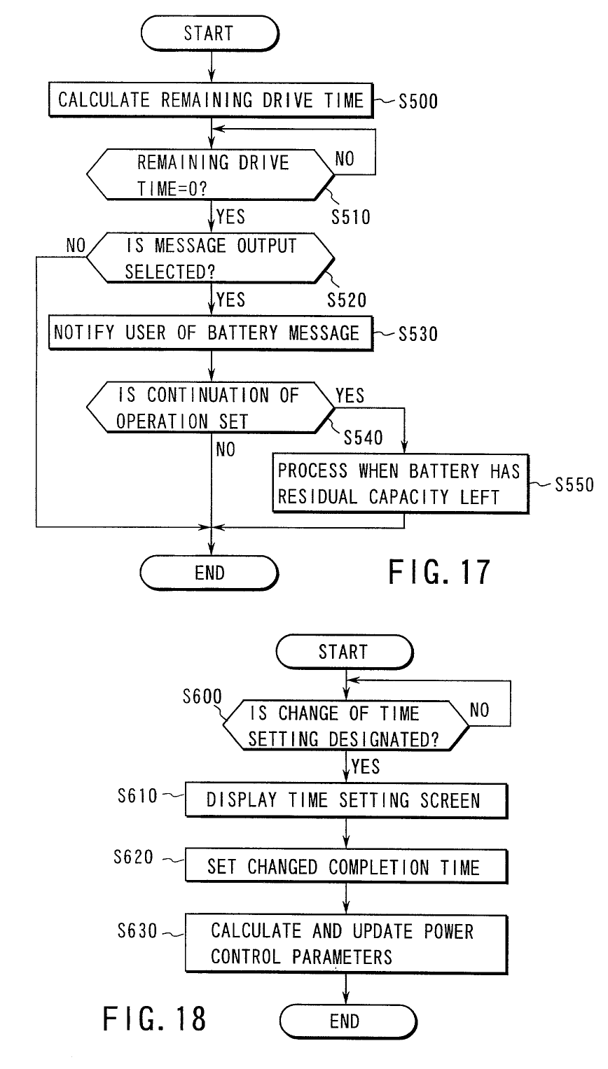

Next, a process of outputting a message when the set (specified) time is reached will be described. FIG. 5 shows a battery message screen of the power control program 201 after the arrival of the set time. FIG. 17 is a flowchart illustrating the operation to be performed when the set driving time is reached.

A battery driving time is set on the time setting screen shown in FIG. 4. In this figure, the current time is indicated to be 10:00 P.M. by way of example. The user simply enters a desired completion time. The power control program 201 subtracts the current time from the set time, i.e., the completion time to determine the remaining driving time (S500).

Upon determining that the remaining driving time has reached zero, i.e., that the specified time has been reached, the power control program 201 makes a decision of whether or not the message output option has been chosen on the time setting screen shown in FIG. 4 (S510 and S520). When the decision is that the message output option has been chosen, a battery message to the effect that Battery power is running out. The message “Do you wish to continue operation?” is indicated to the user in the window shown in FIG. 5 (Yes in S520 and S530).

When the YES button has been chosen on the message window of FIG. 5, that is, when the continuation of processing has been chosen, the power control program 201 will carry out an operation when the battery power is left shown in FIGS. 3 and 12. That is, when the continuation has been set, a decision is made as to which of options has been chosen on the basis of the setting entered in the work area of the main memory 13. When the change of time setting has been chosen, the time setting screen shown in FIG. 4 appears. A completion time is then set and entered again (Yes in S540 and S550).

When judging that the message output option has not been chosen in S520, or when the continuation has not been chosen in S540, or when the power off process has been chosen in S550, the power control program carries out the power off process (immediately-before-power-off process+power off process) (No in S520, No in S540, and S550).

When the user has chosen the option of displaying no message hereafter on the battery message screen of FIG. 5 in step S530, no message will be output next time even if the battery power is left at the specified time and the change of time setting has been set.

Next, reference will be made to FIG. 18 to describe an operation of the power control program 201 to change the time setting.

The power control program 201 in execution makes a decision of whether a command to change the time setting has been received (S600). If the decision is that such a command has been received, then the time setting screen shown in FIG. 4 appears again, whereupon the driving time is changed (extended/reduced) by the user (Yes in S600, S610, and S620).

The power control program 201 calculates new power control parameters according to the changed driving time. The power control parameters already stored in the main memory 13 are updated and each of the updated power control parameters is set up on a corresponding respective one of the devices (S630).

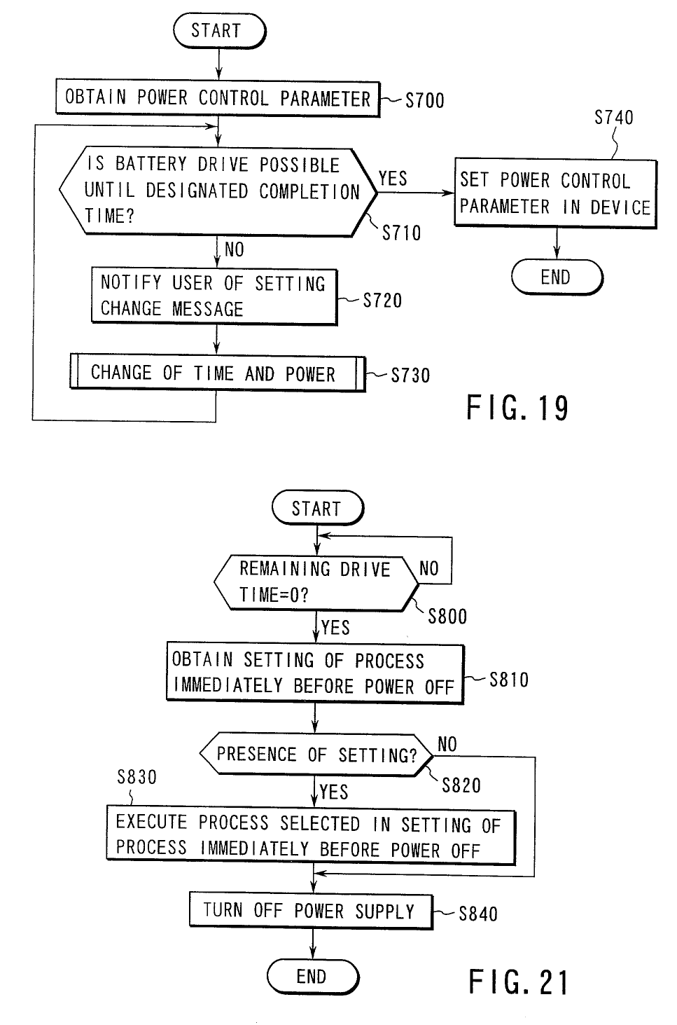

Next, reference will be made to FIGS. 19 and 20 to describe an operation of, when a driving time is set or changed by the user or when a driving time setting is subject to change due to battery exchange, making a decision of whether or not the battery power is available for the user-specified driving time (until the user-specified completion time) and outputting a warning message if not available. FIG. 20 shows a time setting change message output screen.

When a driving time is set or changed by the user or when battery characteristic data is obtained at the time of battery exchange, the power control program 201 reads from the main memory 13 the power control parameters, the maximum charged capacity of the battery, the current residual capacity of the battery, the characteristic data of the battery, and the battery driving time (S700). Based on the read data, a decision is made as to whether or not the battery power is available until the specified time as with steps S240 and S250 in FIG. 13. If not available, then a message “Under current power setting, battery power is not available until specified time. Please change power setting” is indicated to the user as shown in FIG. 20 (No in S710 and S720). The OK button is chosen and the time setting screen of FIG. 4 then appears to prompt the user to change the specified time. At this time, the power setting can also be changed on the power setting screen shown in FIG. 6.

Based on the changed specified time and power setting, the power control program 201 makes a second decision of whether or not the battery power is available. If available, the power control program sets up each of the calculated power control parameters on a corresponding one of the devices (Yes in S710 and S740).

Next, reference is made to FIG. 21 to describe an operation to be performed immediately before the power is turned off.

The power control program 201 obtains time information from the RTC 19 at regular intervals to make a comparison between the current time and the user-specified time stored in the main memory 13 (S800). When the current time reaches the user-specified time, the power control program reads the immediately-before-power-off process setting from the main memory (Yes in S800 and S810).

If any one of file saving process, mail transmission process, battery discharge process, and audio output process shown in FIG. 11 has been selected as a process immediately before power off, the power control program 201 carries out the selected process. For example, if the battery discharge process has been selected, an AC adapter connection message is indicated to the user before the battery discharge process is carried out (Yes in S820 and S830).

Upon detecting the AC adapter being connected, the power control program executes the battery discharge process. After the execution of the immediately-before-power-off process or when no immediately-before-power-off process has been set, the power off process for the information processor is performed (S830 and S840 or No in S820 and S840).

In the present invention, the power control program 201 may be set to have options of saving the power of each of the devices that make up the information processor, adjusting the CPU speed, setting the HDD power-off time, adjusting the LCD brightness, setting up transition conditions of suspend/hybernation, etc., in addition to setting the user-specified time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processor, comprising:
a plurality of devices;
a battery;
means for specifying a battery drive time of the information processor;
means for setting one of a power ratio and priority of power consumptions of the respective devices;
means for calculating power control parameters indicating power consumption states of the respective devices based on the specified battery drive time and the set power ratio or priority of power consumptions; and
control means for controlling the power consumption of the respective devices based on the power control parameters calculated by the calculating means.

2. The information processor according to claim 1, further comprising means for setting the power ratio in units of specified driving time;
wherein the calculating means calculates the power control parameters in units of specified driving time based on the power ratio for every specified driving time; and
the control means controls the power consumptions of the respective devices in accordance with the power control parameters calculated in units of specified driving time.

3. The information processor according to claim 1, further comprising:
means for obtaining the residual capacity of the battery and the current power consumption of the image processor;
second calculating means responsive to the obtaining means for calculating the battery drive time;
means for making a comparison between the battery drive time specified by the specifying means and the current drive time calculated by the second calculating means; and
means responsive to the comparing means for changing the power control parameters calculated by the calculating means.

4. The information processor according to claim 3, wherein the obtaining means further obtains characteristic data of the battery in the information processor and calculates the battery drive time on the basis of the obtained characteristic data of the battery.

5. The information processor according to claim 1, further comprising means for, at the arrival of the battery drive time specified by the specifying means, executing a predetermined process before the power to the information processor is turned off.

6. The information processor according to claim 1, further comprising means for indicating a message to a user in the event that the information processor cannot be driven by the battery until the battery drive time specified by the specifying means is reached.

7. The information processor according to claim 1, further comprising means for changing the battery drive time specified by the specifying means while the information processor is being driven by the battery until the specified drive means is reached.

8. A power control method for use with an information processor having a function of controlling the power of devices constituting a system, comprising the steps of:
specifying a battery drive time of the information processor;
setting one of a power ratio and priority of power consumptions of the respective devices;
computing power control parameters indicating power consumption states of the respective devices on the basis of the battery drive time and the set power ratio or priority of power consumptions; and
controlling the power consumption of the respective devices based on the power control parameters computed by the computing step.

9. The method according to claim 8, further comprising setting the power ratio in units of specified driving time;
wherein the computing step computes the power control parameters in units of specified driving time based on the power ratio for every specified driving time; and
the control step controls the power control parameters of the respective devices in accordance with the power devices in accordance with the power control parameters computed in units of specified driving time.

10. The method according to claim 8, further comprising the steps of:
obtaining the residual capacity of the battery and the current power consumption of the image processor;
computing the battery drive time from the residual capacity of the battery and the current power consumption of the image processor;
making a comparison between the battery drive time specified by the specifying step and the current drive time computed by the computing step; and
changing the power control parameters calculated by the computing step on the basis of the result of the comparison.

11. The method according to claim 10, wherein the obtaining step further includes the step of obtaining characteristic data of the battery in the information processor and computing the battery drive time on the basis of the obtained characteristic data of the battery.

12. The method according to claim 8, further comprising the step of, at the arrival of the battery drive time specified by the specifying step, executing a predetermined process before the power to the information processor is turned off.

13. The method according to claim 8, further comprising the step of indicating a message to a user in the event that the information processor cannot be driven by the battery until the battery drive time specified by the specifying step is reached.

14. The method according to claim 8, further comprising the step of changing the battery drive time specified by the specifying step while the information processor is being driven by the battery until the specified drive means is reached.

15. An information processor, comprising:
a plurality of devices;
a battery;
means for specifying a battery drive time of the information processor;
means for setting a power ratio of the respective devices;
means for calculating power control parameters indicating power consumption states of the respective devices based on the specified battery drive time and the set power ratio; and
control means for controlling the power consumption of the respective devices based on the power control parameters calculated by the calculating means.

16. An information processor, comprising:
a plurality of devices;
a battery;
means for specifying a battery drive time of the information processor;
means for setting a priority of power consumptions of the respective devices;
means for calculating power control parameters indicating power consumption states of the respective devices based on the specified battery drive time and the set priority of power consumptions; and
control means for controlling the power consumption of the respective devices based on the power control parameters calculated by the calculating means.

17. A power control method for use with an information processor having a function of controlling the power of devices constituting a system, comprising the steps of:
specifying a battery drive time of the information processor;
setting a power ratio of the respective devices;
computing power control parameters indicating power consumption states of the respective devices on the basis of the battery drive time and the set power ratio; and
controlling the power consumption of the respective devices based on the power control parameters computed by the computing step.

18. A power control method for use with an information processor having a function of controlling the power of devices constituting a system, comprising the steps of:
specifying a battery drive time of the information processor;
setting a priority of power consumptions of the respective devices;
computing power control parameters indicating power consumption states of the respective devices on the basis of the battery drive time and the set priority of power consumptions; and
controlling the power consumption of the respective devices based on the power control parameters computed by the computing step.
